(19) United States
(12) Patent Application Publication
(10) Pub. No.: US 2025/0050705 A1
(43) Pub. Date: Feb. 13, 2025

(54) RESERVOIR, PREFERABLY FOR A MOTOR VEHICLE

(71) Applicant: MAHLE INTERNATIONAL GMBH, Stuttgart (DE)

(72) Inventors: Hicham ROUHANA, Korntal-Münchingen (DE); Martin SIEVERS, Kernen im Remstal (DE); Uwe FÖRSTER, Erdmannhausen (DE); Kiran PAGARE, Pune (IN); David MAYOR TONDA, Waldenbuch (ES)

(21) Appl. No.: 18/796,598

(22) Filed: Aug. 7, 2024

(30) Foreign Application Priority Data
Aug. 11, 2023 (DE) 102023121627.9

(51) Int. Cl. B60H 1/00

(52) U.S. Cl. CPC B60H 1/00571

(57) ABSTRACT

A reservoir for separating gaseous and liquid portions of a refrigerant from one another and/or collecting and storing the refrigerant is provided, preferably for a motor vehicle, containing a cylinder and an intake tube, in which the cylinder has a lower cylinder cap, the intake tube is inside the cylinder, and refrigerant flows through the intake tube. The intake tube has a reversal region for the refrigerant at the bottom, wherein the reversal region and the lower cylinder cap form an integral part, or are connected to one another. The reversal region contains an oil hole. The assembly (100) has an inner heat exchanger and a reservoir.

### CROSS-REFERENCE TO RELATED APPLICATIONS

This application claims priority from German Patent Application No. DE 10 2023 121 627.9, filed on Aug. 11, 2023, the entirety of which is hereby incorporated by reference herein.

The invention relates to a motor vehicle reservoir and an assembly for collecting and storing refrigerant and separating liquid and gaseous portions of the refrigerant, as well as the use thereof in a refrigerant circuit.

DE 10 2014 113 793 A1 describes a reservoir for a refrigerant circuit in a motor vehicle. The reservoir contains a cylinder (reservoir container) and an intake tube (intake tube assembly). The intake tube has an outer tube (intake tube) and a coaxial inner tube (intake tube), which are connected at the bottom by a connector (connector) to form a flow path. A radial oil hole (oil pan hole) is formed in the connector that connects the oil pan in the reservoir container to the flow path in the intake tube. The oil hole is formed in the connector at the height of the spacing between the lower end of the inner tube and the lower end of the connector. A filter surrounds the connecter where the oil hole is located. By placing the oil hole at the height of the spacing between the lower end of the inner tube and the lower end of the connector, the distance from the oil hole to the bottom of the cylinder is unnecessarily large. This reduces the volume of the reservoir/cylinder that can be used to store refrigerant. Because the cylinder does not have a cylinder cap at the bottom, and it is not connected to the connector, the volume that can be used is further reduced. A refrigerant circuit can contain moving parts, such as a compressor. Oil is needed for lubricating the moving parts to ensure that they functions properly. This oil is added to the refrigerant. The oil is heavier than the refrigerant in the liquid state, and accumulates at the lower end of the reservoir in an oil pan. The oil can be removed from the compressor through the oil hole. Particles and contaminants can accumulate at the bottom of the cylinder. This is because the particles are heavier than the oil. These particles can result from abrasion in hoses, wear debris from the compressor, or shavings formed during the production process. Because the of the excessive distance between the oil hole and the bottom of the cylinder, and the shape of the cylinder, a filter is needed to remove the particles from the oil, and thus protect the moving parts, such as a compressor, against the damage they may cause.

The device according to the invention that has the features of the independent claims, has the advantage that the volume of the reservoir that can be used for storing and separating the phases of the refrigerant is maximized in relation to the size of the reservoir, and in most cases there is no need for an additional filter for filtering the oil.

The basis of the invention is a reservoir. The reservoir according to the invention for separating gaseous and liquid portions of a refrigerant and/or collecting and storing the refrigerant can preferably be used in a motor vehicle. The reservoir according to the invention contains a cylinder and an intake tube. The cylinder has a cylinder cap at the bottom. The intake tube is inside the cylinder. Refrigerant flows through the intake tube. There is a reversal region for the refrigerant at the bottom of the intake tube, which is an integral part of the cylinder cap, or connected thereto. The cylinder can be a circular cylinder with two parallel cylinder caps. The cylinder can be made of plastic. The housing for the reservoir can encompass the cylinder. The housing can be a tube with two end caps made of an aluminum alloy. A refrigerant circuit can comprise a condenser for condensing the refrigerant, a reservoir according to the invention, a vaporizer for vaporizing the refrigerant, a compressor for compressing the refrigerant, and connecting lines. A refrigerant can flow through the refrigerant circuit. The refrigerant flowing through the refrigerant circuit can be R1234yf, for example. Alternatively, carbon dioxide (R744) can flow through the refrigerant circuit. The refrigerant can be stored in the reservoir or cylinder, and released as needed. The reservoir or cylinder can be constructed such that the liquid and gaseous phases of the refrigerant can be separated by gravity. The reversal region in the intake tube can reverse the flow of the refrigerant in the intake tube in either axial direction. This axial direction follows the gravitational path.

In a first embodiment of the reservoir according to the invention, the reversal region can be an integral part of the lower cylinder cap. The reversal region and lower cylinder cap can be made of plastic in an injection molding process. Because the reversal region and lower cylinder cap form an integral part, the volume of the cylinder available for storing and separating the phases of a refrigerant can be advantageously increased without increasing the size of the reservoir, because these components occupy less space therein.

In a second embodiment of the reservoir according to the invention, the reversal region and lower cylinder cap are connected, e.g. with a pressed fit connection. The reversal region and the lower cylinder cap can be made of plastic in an injection molding process. They can be snapped together to obtain a pressed fit connection.

This advantageously increases the volume of the cylinder available for storing and separating the phases of the refrigerant, without increasing the size of the reservoir, because both components occupy less space in the reservoir. The stationary operating point may change in a refrigerant circuit due changes in the external temperature at the condenser for the refrigerant. When the operating point changes, the refrigerant may move in the circuit. This means that refrigerant may enter or exit the reservoir according to the invention. This occurs in a nonlinear fashion, and must be taken into account when designing the refrigerant circuit. Increasing the volume available for storing the refrigerant simplifies the design of the refrigerant circuit. This is because the volume available for storing refrigerant is greater. The phase separation of the refrigerant can at least be improved by increasing the available volume in the reservoir.

The reversal region can contain an oil hole. Oil is added to the refrigerant to lubricate moving parts such as the compressor in the refrigerant circuit. The compressor in the refrigerant circuit can be lubricated with oil suctioned in through the oil hole. Liquid oil is heavier than refrigerant in the liquid state, and accumulates at the bottom of the reservoir, or cylinder, due to the effects of gravity. The oil and the liquid portion of the refrigerant can thus be separated from one another. The reservoir according to the invention contains the intake tube with the reversal region. The oil collects at the bottom of the cylinder. The reversal region and the lower cylinder cap form an integral part, or are connected to one another. This results in a sufficient volume for the oil that is needed, and the volume needed for storing and separating the phases of the refrigerant/oil mixture can advantageously be further increased.

According to the invention, the axial height of the reversal region in the intake tube can be such that the oil hole is above or below the midpoint of this height. The axial height of the reversal region can run in the vertical direction. The axial height can run from the upper end of the reversal region to the lower cylinder cap.

In another embodiment of the reservoir according to the invention, the oil hole can be above the midpoint of the axial height. Particles, contaminants, and foreign bodies accumulate in the bottom of the cylinder. By placing the oil hole above the midpoint of the axial height, the intake of contaminated oil through the oil hole by the compressor can at least be reduced.

In another embodiment of the reservoir according to the invention, the oil hole can be below the midpoint of the axial height. This advantageously further increases the volume available for storing and separating the phases of the refrigerant/oil mixture. The liquid oil accumulates in the bottom of the cylinder. By placing the oil hole above the midpoint of the axial height, it is ensured that only oil can be suctioned through the oil hole by a compressor via the intake tube.

In another embodiment of the reservoir according to the invention, the intake tube can form an integral part. The intake tube can be made of plastic in an injection molding process inexpensively. The intake tube can contain two radially adjacent flow paths and the reversal region. The refrigerant can flow downward in the first flow path. It can then be redirected in the reversal region, and flow upward in the second flow path. The integral intake tube can be connected to the lower cylinder cap with a pressed fit connection

In another embodiment of the reservoir according to the invention, the intake tube can comprise at least two parts. The intake tube can comprise a double tube and a connector. The connector forms the reversal region. The double tube can contain two radially adjacent or coaxial flow paths and the reversal region. The refrigerant can flow downward in the first flow path. It can then be redirected in the reversal region, and flow upward in the second flow path. The reversal region can form a connector, which can be connected to the lower cylinder cap with a pressed fit connection. The double tube and connector can be made of plastic and snapped together to obtain a pressed fit connection. The oil hole can be formed in the connector.

In another embodiment of the reservoir according to the invention, the intake tube can contain at least one tube. The reversal region can form a connector. The connector is connected to the at least one tube. The intake tube can comprise two tubes that are spaced apart radially. The refrigerant can flow downward in the first tube, and upward in the second tube. The intake tube, comprising the tubes and connector, can be made of plastic. The two tubes can be connected to the connector to obtain a pressed fit connection. The connector can be connected to the lower cylinder cap. The oil hole can be located in the connector, between the where the two tubes are connected.

In another embodiment of the reservoir according to the invention, the reversal region in the intake tube can be at least partially surrounded by a filter. Particles may be heavier than the liquid oil and the liquid refrigerant, and accumulate at the bottom of the cylinder. If the oil hole has to be formed much lower than the midpoint of the axial height of the reversal region, particles might be suctioned through the oil hole by the compressor. The filter can remove these particles from the oil. The filter can comprise a fabric that filters out the particles.

In another embodiment of the reservoir according to the invention, the cylinder can have an upper cylinder cap. The intake tube and the upper cylinder cap can be connected to one another. The intake tube can be snapped to the upper cylinder cap to obtain a pressed fit connection. A mixture of refrigerant and oil can flow into the cylinder through holes in the upper cylinder cap.

The upper cylinder cap can contain at least one separating wall. In another embodiment of the reservoir according to the invention, the upper cylinder cap can contain a single separating wall. The separating wall can wind upward around the intake tube at a constant pitch. Consequently, refrigerant flowing in the reservoir can be redirected such that a portion thereof flows along the inner surface of the cylinder. This improves the separation of liquid and gaseous portions of the refrigerant.

Another embodiment of the reservoir according to the invention can contain an axis. The oil hole can be radially spaced apart from the axis. This axial axis can pass through the middle of the upper and lower cylinder caps, thus representing the middle axis of the cylinder. The reservoir may not be precisely parallel to the gravitational pull in a motor vehicle due to installation restrictions. By spacing the oil hole radially apart from the axial axis, this deviation from the direction of the pull of gravity can be compensated for. The radial spacing can also approach zero.

In a first application according to the invention, the reservoir can be used in a refrigerant circuit for a motor vehicle. The reservoir can be that in the first embodiment according to the invention. A refrigerant can flow through the refrigerant circuit. This refrigerant can be R1234yf, for example. The refrigerant can also be carbon dioxide (R744). The refrigerant circuit for a motor vehicle can contain the following: a condenser for the refrigerant, a reservoir according to the invention for separating gaseous and liquid portions of the refrigerant, and/or for collecting and storing the refrigerant, an expansion valve for the refrigerant, a vaporizer for the refrigerant, a compressor for the refrigerant, and connecting lines. Heat can be removed from the interior of a motor vehicle by the vaporizer, and this heat can be discharged into the environment by the condenser. The reservoir can be used to increase the efficiency of the refrigerant circuit in a variety of environmental conditions by storing refrigerant in the reservoir according to the invention and releasing it as needed. The reservoir according to the invention can be structured such that the liquid and gaseous phases of a refrigerant can be separated by the effects of gravity. Different environmental conditions can be understood to be different seasons, for example. Because the refrigerant circuit is closed, and can only contain one reservoir, the refrigerant circuit regulates itself with the aid of the reservoir according to the invention. Oil is necessary for lubricating the compressor in the refrigerant circuit. Liquid oil accumulates at the lower end of the reservoir according to the invention due to the effects of gravity, because liquid oil is heavier than liquid refrigerant can be. The compressor can suction oil through the oil hole, with which it is then lubricated.

In a first embodiment, the assembly contains a heat exchanger and a reservoir. The reservoir can be the first embodiment according to the invention, and contain a cylinder. The heat exchanger can contain a tube and the tube can wind upward around the cylinder at a constant pitch. The heat exchanger can be an internal heat exchanger. The cold low-pressure portion and the warm high-pressure portion of a refrigerant circuit can advantageously exchange heat through the inner heat exchanger. This can result in overheating of the cold low-pressure portion. The assembly can be placed in a warm engine compartment in a motor vehicle. Advantageously, the amount of heat entering the reservoir can at least be reduced because the heat exchanger can be placed between the reservoir and the engine chamber. Undesired heat entering the reservoir can impact the performance of the reservoir.

### DRAWINGS

| | |
|---|---|
| FIG. 1 | Sectional illustration of the assembly composed of a heat |
| | exchanger and the reservoir according to the invention |
| FIG. 2.1 | Detail of the section of the lower part of the reservoir |
| | with a connector containing an oil hole |
| FIG. 2.2 | Detail of the section of the lower part of the reservoir |
| | with a connector containing an oil hole and an additional |
| | filter |
| FIG. 3 | Detail of the section of the upper cylinder cap of the |
| | cylinder |
| FIG. 4 | Sectional illustration of the assembly composed of a heat |
| | exchanger and the reservoir according to the invention |
| FIG. 5 | Exploded view of the assembly composed of a heat exchanger |
| | and the reservoir according to the invention |

FIG. 1 shows a section of a first embodiment of the reservoir A, as part of the assembly 100. The reservoir A and the heat exchanger WT form the assembly 100.

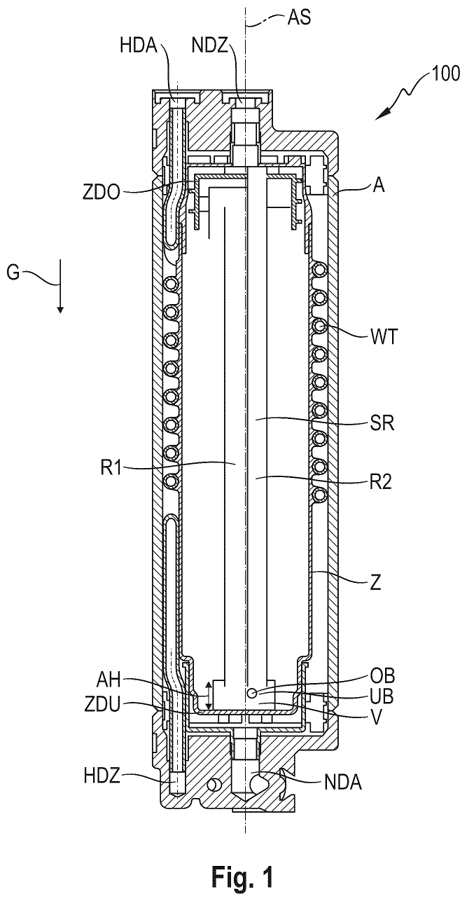

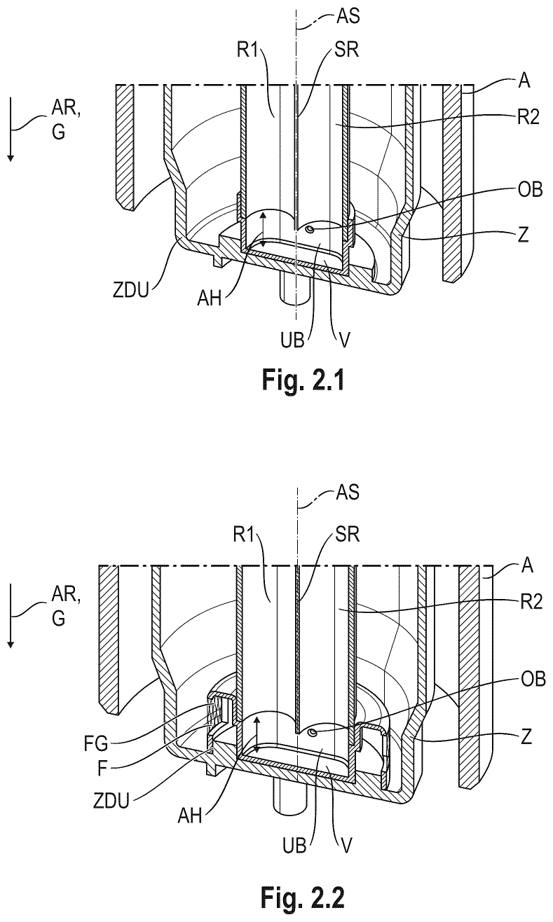

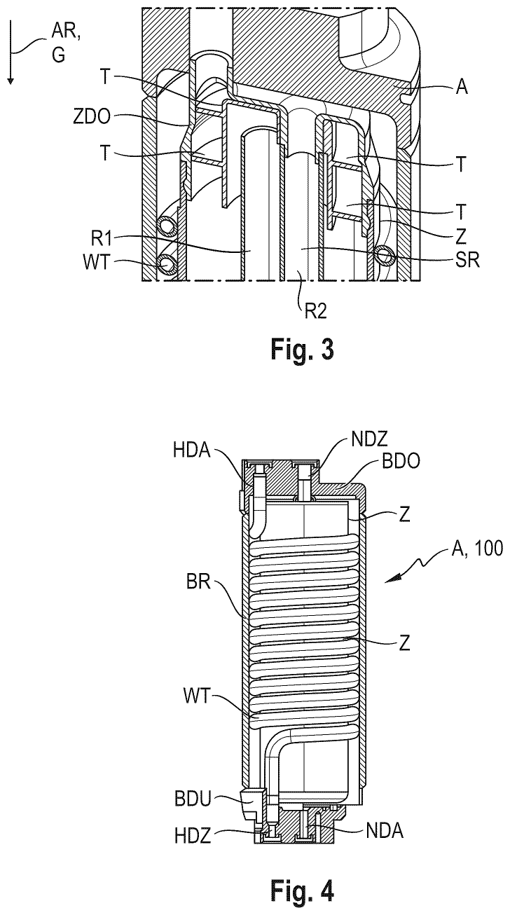

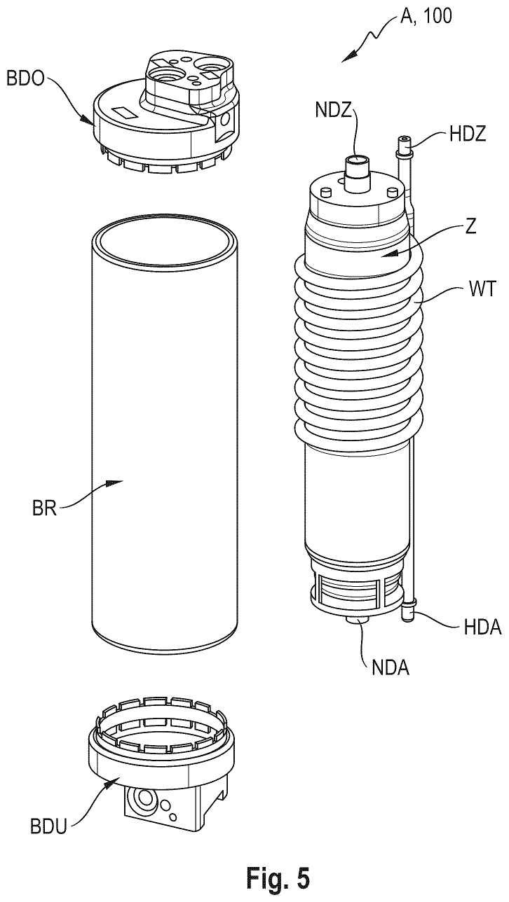

The reservoir A, or assembly 100, substantially forms an elongated cylinder. The axial direction AR runs along the vertical axis of the reservoir A. The axial direction AR follows the pull of gravity G. The term “down” in the reservoir A according to the invention is defined by the pull of gravity G. The axial axis AS of the reservoir A coincides with the vertical axis of the reservoir A. Refrigerant, not shown, can flow through the reservoir A. The refrigerant can be carbon dioxide (R744). Gaseous and liquid portions of refrigerant can be separated from one another and stored in the reservoir A. The reservoir A contains the cylinder Z with the upper cylinder cap ZDO and the lower cylinder cap ZDU. The lower cylinder cap ZDU is at the bottom. The intake tube SR is in the cylinder Z, and refrigerant flows through it. The phase separation, collection and storage of refrigerant can take place in the cylinder Z. The heavier liquid portion of the refrigerant sinks due to gravity, thus resulting in the phase separation. The heat exchanger WT is composed of a tube that winds around the cylinder Z at a constant pitch in the axial direction AR. The heat exchanger WH can be connected to the cylinder Z with a pressed fit connection. The refrigerant (gaseous and/or liquid) is suctioned in by the intake tube SR from a compressor (not shown). The intake tube SR has a reversal region UB at the bottom, where the refrigerant is redirected in the axial direction AR. The reversal region UB is connected to the lower cylinder cap ZDU to obtain a pressed fit connection. The lower reversal region UB and the lower cylinder cap UB are separate parts. The reversal region UB forms a connector V. The intake tube contains two tubes R1, R2. The two tubes R1, R2 are connected to one another by the connector V with a pressed fit connection. The connector V is connected to the lower cylinder cap ZDU with a pressed fit connection. The intake tube SR thus comprises three parts. The two tubes R1, R2 form a double tube. These tubes R1, R2 are adjacent to one another. The upper end of the intake tube SR is connected by the two tubes R1, R2 to the upper cylinder cap ZDO in a pressed fit connection. Because the intake tube SR and the lower cylinder cap ZDU are connected together, the volume available for storage and/or phase separation of the refrigerant is advantageously maximized within the reservoir A according to the invention. The reversal region UB and therefore the connector V is cylindrical, and has an axial height AH extending along the axial direction AR. The refrigerant can be mixed with oil. A compressor (not shown) can be lubricated with the oil, for example. The heavier liquid portion of the refrigerant sinks with the oil, while lighter gaseous portion of the refrigerant accumulates in the upper part of the cylinder Z. Because the oil is heavier than the liquid refrigerant, the oil accumulates below the liquid refrigerant in the lower part of the cylinder Z, also referred to as the oil pan. This allows the oil to be separated from the refrigerant. The reversal region UB in the intake tube contains the oil hole OB. The oil hole OB is located in the connector V. The oil hole OB is at a radial spacing to the axial axis AS. The oil hole OB is located above the midpoint of the axial height AH. Liquid oil (not shown) that has accumulated in the bottom of the cylinder can be suctioned off through the intake tube SR via oil hole OB by a compressor. Particles may accumulate in the bottom of the cylinder Z (e.g. foreign bodies, sludge, compressor debris, or rubber particles from hoses). Because the oil hole OB is placed axially above the midpoint of the axial height, this reduces the probability of these particles being contained in the oil that is suctioned off. The reservoir A has a high-pressure intake HDZ at the bottom, and a high-pressure outlet HDA at the top, as well as a low-pressure intake NDZ at the top and low-pressure outlet NDA at the bottom. The reservoir A is connected to the high-pressure portion of the refrigerant circuit by the high-pressure intake NDZ and the high-pressure outlet HDA. The reservoir A is connected to the low-pressure portion of the refrigerant circuit by the low-pressure intake NDZ and the low-pressure outlet NDA. A dry bag (not shown) can be placed inside the cylinder Z. Heat can be exchanged between the cold low-pressure portion and the warm high-pressure portion of a refrigerant circuit (not shown) through the heat exchanger WH.

A sectional illustration of a first embodiment and a second embodiment of the lower part of the reservoir A is shown in FIG. 2. The cylinder Z is placed with the lower cylinder cap ZDU in the reservoir. The axial direction AR follows the pull of gravity G. The reservoir has an axial axis AS that runs along its vertical axis. The intake tube SR is in the cylinder Z and has a reversal region UB. The reversal region UB is connected to the lower cylinder cap ZBU with a pressed fit connection. The flow of refrigerant (not shown) can be reversed in the reversal region UB along the axial direction AR. The intake tube SR contains two tubes R1, R2 and the reversal region UB. The reversal region UB forms a connector V between the two tubes R1, R2. The two tubes R1, R2 and the connector V are held together with a pressed fit connection. The reversal region UB comprising the connector V is connected to the lower cylinder cap ZDU in a pressed fit connection such that the reversal region UB is connected to the lower cylinder cap ZDU, and in this manner comprises two parts. The reversal region UB comprising the connector V is cylindrical and has an axial height AH running in the axial direction AR. The axial height AH runs from the lower cylinder cap ZDU to the upper end of the reversal region UB. The oil hole OB is formed in reversal region UB. The oil hole is at a radial spacing to the axial axis. The oil hole has a diameter of 1.1 mm. Particles (e.g. foreign bodies, sludge, compressor grit, or rubber particles from hoses) can accumulate in the bottom of the cylinder.

A section of a first embodiment of the reservoir A according to the invention is shown in FIG. 2.1. The oil hole OB is above the midpoint of the axial height AH. Particles can accumulate in the bottom of the cylinder Z, below the oil hole OB. This at least hinders or prevents these particles or foreign bodies from being suctioned off.

A section of a second embodiment of the lower part of the reservoir A according to the invention is shown in FIG. 2.2. The oil hole OB is below the midpoint of the axial height AH. A filter F surrounds the reversal region UB. The filter F contains a filter fabric FG. Particles can be filtered out by the filter fabric FG to filter the oil (not shown).

A section of a first embodiment the upper part of the reservoir A according to the invention is shown in FIG. 3. The cylinder Z with the upper cylinder cap ZDO is inside the reservoir A. The intake tube SR is inside the cylinder Z and comprises two tubes R1, R2 and the reversal region, which is not shown here. The two tubes R1, R2 are connected to the upper cylinder cap ZDO with a pressed fit connection. The upper cylinder cap ZDO is cylindrical. A separating wall T is formed in the upper cylinder cap ZDO. The separating wall T winds upward around the vertical axis of the cylinder Z at a constant pitch. A portion of the refrigerant can be deflected by the separating wall T such that it flows along the inner surface of the cylinder Z. This improves the separation of the liquid and gaseous phases of the refrigerant.

A sectional view of the assembly 100 containing the first embodiment of the reservoir A according to the invention is shown in FIG. 4. The assembly 100 has an upper assembly cap BDO, an assembly tube BR, and a lower assembly cap BDU. The assembly caps BDO, BDO can be made of an aluminum alloy. The intake tube, not shown here, is in the cylinder Z in the reservoir A. The cylinder Z can be made of plastic. The tube forming the heat exchanger WH winds helically around the cylinder Z. The assembly 100, or heat exchanger WH, can be connected to the high-pressure portion of a refrigerant circuit, not shown, by the high-pressure intake HDZ and the high-pressure outlet HDA to form a high-pressure channel. The assembly 100 can be connected to the low-pressure portion of the refrigerant circuit by the low-pressure intake NDZ and the low-pressure outlet NDA. A low-pressure channel, not shown, can be formed between the windings of the heat exchanger WH. The cold low-pressure portion and the warm high-pressure portion of a refrigerant circuit can exchange heat via the heat exchanger WH.

FIG. 5 shows an exploded view of the assembly 100 containing the first embodiment of a reservoir A according to the invention. The assembly 100 has an upper assembly cap BDO, an assembly tube BR and a lower assembly cap BDU. The reservoir contains the cylinder Z. The tube forming the heat exchanger WH winds helically around the cylinder Z. The assembly 100, or heat exchanger WH, can be connected to the high-pressure portion of a refrigerant circuit, not shown, by the high-pressure intake HDZ and the high-pressure outlet HDA. The assembly 100 can be connected to the low-pressure portion of the refrigerant circuit, not shown, by the low-pressure intake NDZ and the low pressure outlet NDA. The cold low-pressure portion and the warm high-pressure portion of a refrigerant circuit can exchange heat via the heat exchanger WH.

The specification can be readily understood with reference to the following Representative Paragraphs:

Representative Paragraph 1. A reservoir (A) for separating gaseous and liquid portions of a refrigerant from one another and/or collecting and storing the refrigerant, preferably for a motor vehicle, containing:
a cylinder (Z)
an intake tube (SR)
wherein the cylinder (Z) has a lower cylinder cap (ZDU)
wherein the intake tube (SR) is inside the cylinder (Z)
wherein refrigerant flows through the intake tube (SR) characterized in that the intake tube (SR) has a reversal region (UB) for the refrigerant at the bottom, wherein the reversal region (UB) and the lower cylinder cap (ZDU) form an integral part, or are connected to one another.

Representative Paragraph 2. The reservoir (A) according to Representative Paragraph 1, characterized in that the reversal region (UB) contains an oil hole (OB).

Representative Paragraph 3. The reservoir (A) according to Representative Paragraph 1 or 2, characterized in that the reversal region (UB) in the intake tube (SR) has an axial height (AH), wherein the oil hole (OB) is above or below the midpoint of the axial height (AH).

Representative Paragraph 4. The reservoir (A) according to Representative Paragraph 1, 2 and 3, characterized in that the intake tube (SR) forms an integral part.

Representative Paragraph 5. The reservoir (A) according to Representative Paragraph 1, 2 and 3, characterized in that the intake tube (SR) comprises at least two parts.

Representative Paragraph 6. The reservoir (A) according to Representative Paragraph 5, characterized in that the intake tube (SR) contains at least one tube (R1, R2), wherein the reversal region (UB) forms a connector (V), wherein the connector (V) is connected to the at least one tube (R1, R2).

Representative Paragraph 7. The reservoir (A) according to Representative Paragraph 4 or 5, characterized in that the reversal region (UB) in the intake tube (SR) is at least partially surrounded by a filter (F).

Representative Paragraph 8. The reservoir (A) according to any of the preceding Representative Paragraphs, characterized in that the cylinder (Z) has an upper cylinder cap (ZDO), and the intake tube (SR) and the upper cylinder cap (ZDO) are connected to one another.

Representative Paragraph 9. The reservoir (A) according to any of the preceding Representative Paragraphs, characterized in that the upper cylinder cap (ZDO) has at least one separating wall (T).

Representative Paragraph 10. The reservoir (A) according to any of the preceding Representative Paragraphs, characterized in that the reservoir (A) has an axis (AS), wherein the oil hole (OB) is at a radial spacing to the axis (AS).

Representative Paragraph 11. A refrigerant circuit for a motor vehicle that has a reservoir (A) according to at least one of the preceding Representative Paragraphs 1 to 10.

Representative Paragraph 12. An assembly (100), preferably for a motor vehicle, containing a heat exchanger (WH) and a reservoir (A) according to at least one of the preceding Representative Paragraphs 1 to 10.

List of Reference Symbols

| | |
|---|---|
| A | Reservoir according to the invention |
| 100 | Assembly comprising a heat exchanger and a reservoir according |
| | to the invention |
| SR | Intake tube |
| UB | Lower reversal region of the intake tube |
| V | Connector forming the reversal region |
| R1, R2 | Tubes forming the intake tube |
| OB | Oil hole |
| AR | Axial direction |
| G | Gravity |
| AH | Axial height of the connector/reversal region |
| AS | Axial axis of the reservoir |
| WT | Heat exchanger |
| Z | Cylinder |
| ZDO | Upper cap of the cylinder |
| ZDU | Lower cap of the cylinder |
| ZDZ | Low-pressure intake |
| NDA | Low-pressure outlet |
| HDZ | High-pressure intake |
| HDA | High-pressure outlet |
| F | Filter |
| FG | Filter fabric |
| T | Separating wall |
| BR | Assembly tube |
| BDO | Upper cap of the assembly |
| BDU | Lower cap of the assembly |

1. A reservoir for separating gaseous and liquid portions of a refrigerant from one another and/or collecting and storing the refrigerant, preferably for a motor vehicle, containing:
a cylinder
an intake tube
wherein the cylinder has a lower cylinder cap
wherein the intake tube is inside the cylinder
wherein refrigerant flows through the intake tube
wherein the intake tube has a reversal region for the refrigerant at the bottom, wherein the reversal region and the lower cylinder cap form an integral part, or are connected to one another.

2. The reservoir according to claim 1, wherein the reversal region contains an oil hole.

3. The reservoir according to claim 1, wherein the reversal region in the intake tube has an axial height, wherein the oil hole is above or below the midpoint of the axial height.

4. The reservoir according to claim 1, wherein the intake tube forms an integral part.

5. The reservoir according to claim 1, wherein the intake tube comprises at least two parts.

6. The reservoir according to claim 5, wherein the intake tube contains at least one tube, wherein the reversal region forms a connector, wherein the connector is connected to the at least one tube.

7. The reservoir according to claim 4, wherein the reversal region in the intake tube is at least partially surrounded by a filter.

8. The reservoir according to claim 1, wherein the cylinder has an upper cylinder cap, and the intake tube and the upper cylinder cap are connected to one another.

9. The reservoir according to claim 1, wherein the upper cylinder cap has at least one separating wall.

10. The reservoir according to claim 1, wherein the reservoir has an axis, wherein the oil hole is at a radial spacing to the axis.

11. A refrigerant circuit for a motor vehicle that has a reservoir according to claim 1.

12. An assembly, preferably for a motor vehicle, containing a heat exchanger (WH) and a reservoir according to claim 1.
